(19) United States
(12) Patent Application Publication
(10) Pub. No.: US 2010/0288878 A1
(43) Pub. Date: Nov. 18, 2010

(54) LOAD DETECTION IN AN AIRCRAFT LANDING GEAR

(75) Inventor: Ian Bennett, Gloucestershire (GB)

Correspondence Address: MERCHANT & GOULD PC, P.O. BOX 2903, MINNEAPOLIS, MN, 55402-0903, US

(73) Assignee: Messier-Dowty Limited, Gloucester (GB)

(21) Appl. No.: 12/682,529

(22) PCT Filed: Oct. 13, 2008
(86) PCT No.: PCT/EP2008/063743

§ 371 Date: Aug. 6, 2010

(30) Foreign Application Priority Data
Oct. 9, 2007 (GB) 0719732.0

(51) Int. Cl. B64C 25/58; G01L 7/00

(52) U.S. Cl. 244/104 FP; 702/50

(57) ABSTRACT

A landing gear for an aircraft includes a shock absorber strut (1) with upper and lower telescoping portions (2, 3), the upper portion (2) being connectable to the airframe of the aircraft. An arm (4) extends fore and aft relative to the aircraft and carrying a landing wheel, (7, 7¹), and pivotally connects by a main pivot (5) to the lower portion (3) of the shock absorber strut. A load reacting unit (9) connects between the arm (4) and the shock absorber strut (1) for reacting to load applied between the arm and shock absorber strut on landing. An indicator (60) monitors the load applied to the load reacting unit (9) on landing. The load reacting unit (9) may be connected between a forward end of the arm (4) and the upper portion (2) of the shock absorber strut to make the gear act as a semi-levered landing gear. Alternatively, the load reacting unit (9) may be connected between the arm (4) and the lower portion (3) of the shock absorber strut to act as a pitch trimmer. The arm (4) may include a bogie beam with fore and aft landing wheels (7, 7¹) with the main pivot (5) therebetween. The load reacting unit (9) preferably has a fluid pressure unit and the indicator (60) includes a mechanical indicator that operates at a predetermined pressure threshold.

The present invention relates to load detection in a landing gear for an aircraft.

It is desirable to monitor the loading applied to a landing gear during an overload landing in order to determine whether the designed strength level has been exceeded, or is in danger of being exceeded.

It is also desirable to monitor the landing load during a normal landing in order to assess the fatigue loading applied to the gear.

According to the invention, a landing gear for an aircraft comprises a shock absorber strut with upper and lower telescoping portions, the upper portion being connectable to the airframe of the aircraft; an arm to extend fore and aft relative to the aircraft and carrying a landing wheel, and pivotally connected by a main pivot to the lower portion of the shock absorber strut; and a load reacting unit connected between the arm and the shock absorber strut for reacting to load applied between the arm and shock absorber strut on landing, and an indicator for monitoring the load applied to the load reacting unit on landing.

The invention recognises that friction from sliding bearings in the shock absorber strut make a significant difference to the load for a given shock absorber internal pressure (or alternatively the shock absorber pressure may be different for the same applied load, depending upon bearing friction). Bearing friction is highly variable, depending upon the coefficient of friction and the load applied normal to the bearings.

Thus the invention recognises that more accurate measurement of load can be made by measuring the load in the load reacting unit, which is less affected by friction than the shock absorber strut. That is, in a fluid pressure load reacting unit the pressure is much more closely related to the load applied to the arm than is the pressure in the shock absorber strut.

The load reacting unit may be pin-jointed, or mounted on spherical bearings at each end, resulting in minimal loading normal to its sliding bearings.

The fluid may be air (or another gas), but more preferably is a liquid.

In the embodiments described below, the arm, may be the arm of semi-levered landing gear, and/or a bogie beam with fore and aft landing wheels.

The invention will now be described by way of example with reference to the accompanying drawings in which:

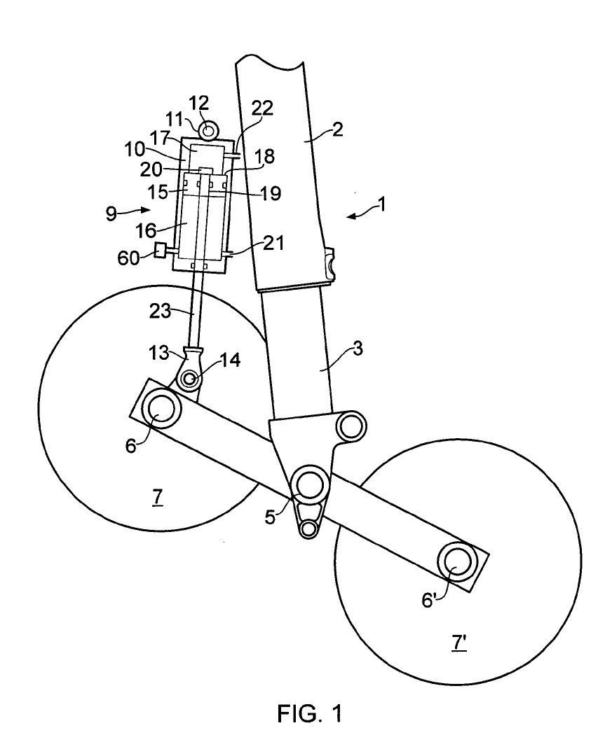

FIG. 1 is a schematic drawing of a semi-levered landing gear for an aircraft according to a first embodiment of the invention;

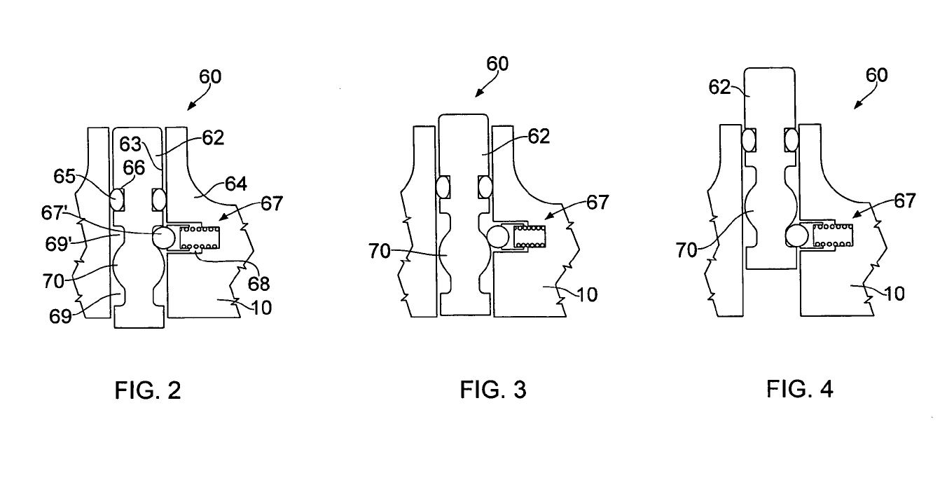

FIG. 2 is a section through the indicator in FIG. 1 shown in the non-operated state;

FIG. 3 is a section similar to that of FIG. 2 showing the indicator partially operated;

FIG. 4 is a section similar to FIG. 2 showing the indicator fully operated;

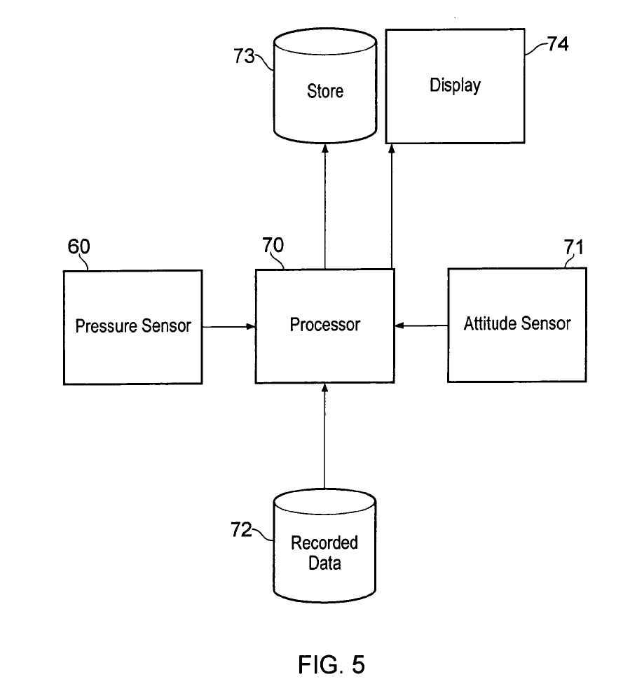

FIG. 5 is a schematic drawing showing various electronic components connected to the pressure sensor;

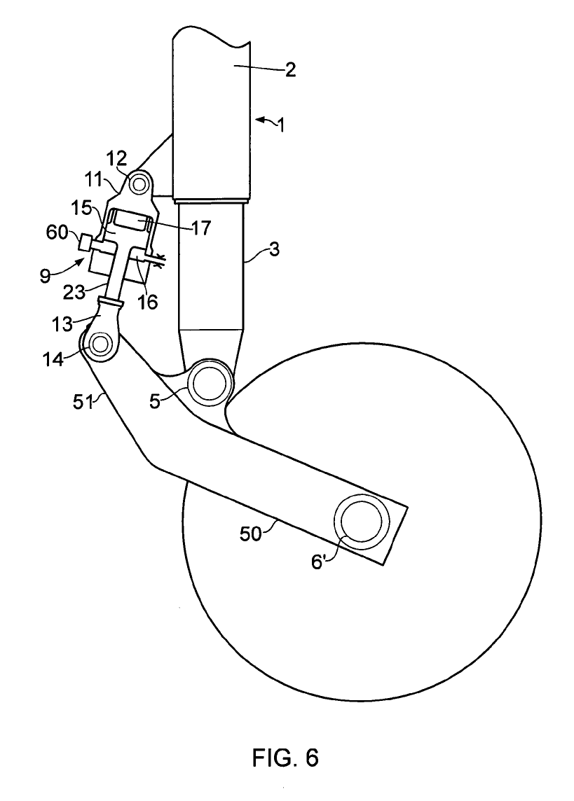

FIG. 6 is a schematic drawing of a semi-levered landing gear for an aircraft according to a second embodiment of the invention; and

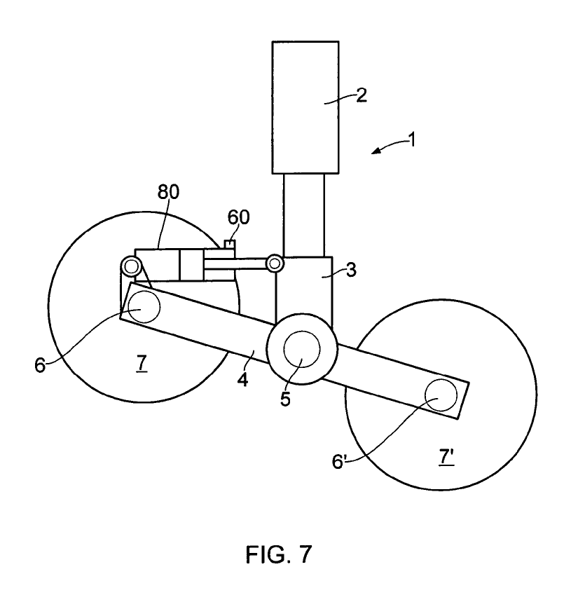

FIG. 7 is a schematic drawing of a rocking bogie landing gear for an aircraft according to a third embodiment of the invention.

The landing gear illustrated in FIG. 1 comprises a main hydraulic shock absorber strut 1 comprising an upper portion 2 connectable to the underside of an aircraft at its upper end, and a lower portion 3 which telescopes within the upper portion 2 during take-off and landing. A bogie beam 4 extends fore and aft of the aircraft and is pivotally connected to the bottom of the lower portion 3 by a main pivot 5 in the mid-region of the bogie beam 4. Axles 6, 6′ are mounted at each end of the bogie beam 4 and carry wheels 7, 7′. The internal construction of the main strut 1 is not shown in FIG. 1 but it may take a conventional form such as shown in GB1510554 and contain pressurised oil and gas.

A load reacting unit 9 is connected between the upper portion 2 of the main strut and the forward section of the bogie beam 4 to control the angular position of the bogie beam during taxiing, take-off and landing. The unit 9 comprises an outer cylinder casing 10 with a closed upper end carrying an upper connector 11 which is pivotally connected at 12 to the upper end 2 of the main strut. A piston rod 23 extends from the lower end of the cylinder casing 10 and carries a lower connector 13 which is pivotally connected at 14 to the front end of the bogie beam between the axle 6 and the main pivot 5. A side stay (not shown) is connected between the upper portion 2 of the shock absorber strut and the aircraft, and moves with the strut when the landing gear is moved to a stowed position in the aircraft by a stowing actuator (not shown).

The load reacting unit 9 has a piston 15 within the cylinder casing 10 that divides the internal space into a high pressure chamber 16 on one side of the piston and a low pressure chamber 17 on the other side of the piston with an internal shoulder 18 between the two chambers 16, 17 against which the piston is urged by high pressure fluid within the chamber 16. The piston rod 23 extends through an axial aperture 19 in the piston and carries a retainer 20 at its inner end to hold the piston 15 captive on the rod 23. A tensile force applied between the connectors 11, 13 will cause the retainer to engage the piston 15 and for the two to move together in acting against the high pressure fluid, which flows in a hydraulic control circuit including a high pressure port 21 with a flow restrictor. When the applied tensile force is released, the rod 23 and piston 15 return to the position shown in FIG. 1 with the piston 15 seating against the shoulder 18, and the rod 23 will extend further into the lower pressure chamber 17 if moved further by the bogie beam 4. The low pressure chamber 17 is connected into the control circuit via a low pressure port 22.

In an alternative embodiment of the invention, movement of the piston 15 and piston rod 23 with the tensile load may be accommodated by valving in the piston to allow the flow of oil between the chambers 16, 17 either side of the piston, the flow being more restricted when the unit is extending, compared with the flow when the unit is retracting.

In operation, the bogie beam 4 is tilted into the position shown in FIG. 1 with the rear wheel 17′ contacting the ground on landing. The bogie beam 4 then rotates anticlockwise, thereby compressing the strut 1. The high pressure in the load reacting unit 9 ensures that there is little or no extension of unit 9. The shortening of the strut 1 continues until the forward wheel 7 makes contact with the ground, thereby relieving the tensile load in the unit 9. The load reacting unit 9 then contracts to accommodate the shortening of the main strut 1. The main strut 1 then functions as a conventional shock absorber.

Thus on landing, the load reacting unit 9 is pressurised, and the pressure can be taken as indicative of the landing load. Therefore, a landing load indicator 60 is provided in the unit 9 to be responsive to the internal fluid pressure. The indicator 60 shown in FIG. 2 comprises a bobbin 62 that is a slide fit in a bore 63 of a body 64 that is exposed at an inner end to the fluid pressure and opens to the exterior of the unit 9 for inspection by service engineers. The bobbin 62 is sealed in the bore 63 by an 0-ring seal 65 seated in an annular groove 66 in the bobbin. In order to limit movement of the bobbin 62 in the bore 63, a spring-loaded detent 67 is mounted in a lateral bore 68 in the body 64 so as to be urged towards the bore 63. The detent 67 has a rounded end formed by a ball 67′ which engages a profiled surface of the bobbin 62. The profile consists of two annular grooves 69, 69′ spaced apart by a barrel-shaped shoulder 70 over which the rounded end of the detent 67 rides as the bobbin moves from the normal retracted position of FIG. 2 to an extended overload indicating position of FIG. 4. The barrel shape of the shoulder 70 ensures a controlled movement of the bobbin 62 with increasing pressure as shown in FIG. 3, and the force of the engagement of the detent 67 with the bobbin once it has passed the crown of the barrel-shaped shoulder 70 serves to assist operation to the extended position. Once the indicator has been operated, the force of engagement of the detent in the groove 69′ is sufficient to hold the bobbin in place under increased internal fluid pressure.

The bobbin 62 is preferably painted a bright colour to increase its visibility once operated. The bobbin 62 may be reset by manual depression or, if needed, a special tool or key may be provided.

The invention makes use of the close correlation between the pressure in the load reaction unit 9 and the load on the aft axle 4, on touchdown. The bearing friction for the auxiliary actuator 9 will be small, because it is mounted on spherical bearings 12, 14 at each end. Friction at the bogie pivot 5 and seal friction will also exist, but can be shown to be small. Furthermore the bogie will always be rotating in the same direction during initial compression on landing. Therefore the results can be compensated to account for the mean friction value, with the only remaining error being due to a variation in friction.

The appropriate pressure threshold value at which the indicator operates may be determined after taking into account the normal aircraft attitude and landing gear geometry, acceptable landing gear load limits, and an allowance for variations or tolerances.

A single indicator 60 may be provided in the load reaction unit 9 to give an indication of the occurrence of an overload condition during landing. Alternatively, two or more indicators 60 may be provided, each set to operate at a different internal fluid pressure so that different load thresholds can be indicated. For example, two indicators can between them define an indicator range with one operating at a lower pressure and the other at a higher pressure. Different indicators may serve to trigger different inspection and safety procedures. Alternatively, multiple indicators 60 may be set to operate at slightly different pressures to reduce error margins due to tolerances.

In an alternative embodiment of the invention, the indicator 60 may comprise a pressure sensor rather than a mechanical pressure threshold indicator. Means may be provided to monitor pressure variations and to indicate when a threshold has been exceeded.

FIG. 5 is a schematic representation of a load detection system which incorporates a pressure sensor 60 comprising a load transducer with an electrical output corresponding to sensed pressure in the load reacting unit 9.

The output of the pressure sensor is received by a processor 75 which records the raw pressure data in a store 73. Simple geometry determines a relationship between the load in the unit 9 and the load applied to the aft axle by using a method such as comparing moments about the shock absorber to bogie pivot. This relationship is predetermined and stored in a recorded data store 72, enabling the processor 75 to derive a value indicative of the load applied to the aft axle from the pressure data and store the aft axle load values in the store 73.

The processor 75 may be set to determine whether the output of the pressure sensor, or a value derived therefrom (such as the aft axle load) has exceeded a pre-set threshold.

A potential drawback is that the moment about the bogie pivot 5 depends upon the direction of the load at the aft axle as well as its magnitude. Thus the processor 73 makes assumptions about the load direction based upon real-time data received from sensors such as aircraft attitude sensor 71, and pre-recorded data such as runway coefficient of friction, rolling stock inertia stored in pre-recorded data store 72. In this way, the processor 75 calculates the direction of the load applied to the aft axle and processes the measured direction to calculate a load value.

Also, the movement about the bogie axle 5 is dependent upon the coefficient of friction between the tyre of the wheel 7 and the runway on touchdown. In order to compensate for this variation, the recorded data store 72 may include a database of airport runway coefficient of friction values compensated for weather conditions. Alternatively, the system may make use of coefficient of friction data transmitted by another aircraft having just landed on the same runway. Alternatively, tyre spin-up rates may be measured, for example, by comparing spin-up time with ground speed and known rolling stock inertia, to determine coefficient of friction. Alternatively, coefficient of friction may be determined through the drag loading on a landing gear.

The measurement of load in the load reacting unit 9 (and hence aft axle load) may be used as part of a comprehensive load measuring system. The load measurement may be processed by the processor 75 in combination with the results from other sensors in order to obtain a more complete indication of all the loads applied.

A display device 74 can display a variety of indications, including the raw pressure data, the aft axle load data, or simply an indication of an overload landing when the pressure has exceeded the pre-set threshold.

Another embodiment of the invention shown in FIG. 6 is similar to the embodiment of FIG. 1, and the same reference numerals are used for similar components. The bogie beam 4 of FIG. 1 is replaced by a beam with an aft arm 50 carrying the wheel 7′, and a forward arm 51 (which does not carry a wheel) carrying a load reacting unit 9. The load reacting unit 9 has an upper connector 11, an upper pivot 12 for pivotally connecting the upper connector to the upper portion of the shock absorber strut 2, a lower connector 13, and a lower pivot 14 for pivotally connecting the lower connector to the forward arm 51. A telescopic unit comprising cylinder casing 10, piston 15 and piston rod 23 contains fluid for reacting to load applied between the upper and lower connectors, and a pressure indicator or sensor 60 is provided for monitoring the pressure in the fluid. A hydraulic circuit is also provided to react the tensile loading and compensate for fluid loss or differential displacement areas. The upper chamber 17 may be connected to atmospheric pressure.

Another embodiment of the invention is illustrated in FIG. 7, as applied to a rocking bogie landing gear fitted with a pitch trimmer 80 to control the position of the bogie on landing. Rotation of the bogie about the pivot 5 on landing is resisted by the pitch trimmer 80, which increases the hydraulic pressure of one or more internal chambers. A landing load indicator 60 is provided in the pitch trimmer 80 to be responsive to the internal hydraulic pressure, and may be designed to operate in a similar manner to the indicator 60 described in the earlier embodiments. The pitch trimmer 60 will not experience reaction loads as large as those of the load reaction units 9 in FIGS. 1 and 6 but the same operating principles apply.

In another embodiment of the invention, the landing load indicator in FIG. 7 may be adapted to be responsive to speed of reaction movement in the pitch trimmer. For example, a differential pressure within the pitch trimmer might be monitored representing a rate of flow of hydraulic fluid and thus a reaction movement. A sensor signal generated by the indicator is monitored to detect reaction movements corresponding to a heavy landing.

In other embodiments of the invention, the pitch trimmer 80 in FIG. 7 may be connected between the aft end of the bogie 4 and the lower portion 3 of the shock absorber strut.

1. A landing gear for an aircraft comprising: a shock absorber strut with upper and lower telescoping portions, the upper portion being connectable to the airframe of the aircraft; an arm to extend fore and aft relative to the aircraft and carrying a landing wheel, and pivotally connected by a main pivot to the lower portion of the shock absorber strut;
and a load reacting unit connected between the arm and the shock absorber strut for reacting to load applied between the arm and shock absorber strut on landing, and an indicator for monitoring the load applied to the load reacting unit on landing.

2. A landing gear as claimed in claim 1 in which the load reacting unit is connected between a forward end of the arm and the upper portion of the shock absorber strut and serves to make the gear act as a semi-levered landing gear.

3. A landing gear as claims in claim 1 in which the load reacting unit is connected between the arm and the lower portion of the shock absorber strut to act as a pitch trimmer.

4. A landing gear as claimed in claim 3 in which the load reacting unit is connected between the forward end of the arm and the lower portion of the shock absorber.

5. A landing gear as claimed in claim 1, wherein the arm comprises a bogie beam with fore and aft landing wheels with the main pivot therebetween.

6. A landing gear as claimed in claim 1, in which the load reacting unit comprises a fluid pressure unit and the indicator is responsive to pressure in the unit.

7. A landing gear as claimed in claim 6 in which the indicator comprises a mechanical indicator exposed to pressure in the unit so as to be operated at a predetermined pressure threshold.

8. A landing gear as claimed in claim 7 in which the mechanical indicator cooperates with a spring-loaded detent that defines a normal position and an operated position of the indicator.

9. A landing gear as claimed in claim 5 comprising two or more indicators set to operate at different threshold pressures.

10. A landing gear as claimed in claim 6 in which the indicator comprises a pressure sensor generating an output signal in accordance with sensed pressure.

11. A landing gear as claimed in claim 10 further comprising means for recording the output of the pressure sensor.

12. A landing gear as claimed in claim 11 further comprising means for determining whether the output of the pressure sensor, or a value derived therefrom, has exceeded a pre-set threshold.

13. A landing gear as claimed in claim 6 in which the indicator comprises a hydraulic sensor generating an output signal in accordance with the speed of reaction movement in the load reacting unit.

14. A landing gear as claimed in claim 1, wherein one or both of pivots connecting the load reacting unit to the arm and shock absorber strut comprise spherical bearings.

15. A landing gear as claimed in claim 1, wherein one or both of pivots connecting the load reacting unit to the arm and shock absorber strut comprise pin joints.

16. A landing gear as claimed in claim 9 further comprising a load calculator for processing the output of the pressure sensor to calculate a value indicative of the load applied to the arm.

17. A landing gear as claimed in claim 16 further comprising a sensor for sensing the direction of the load applied to the arm and generating an output which is processed by the load calculator to calculate a value indicative of the load applied to the arm.

18. A landing gear as claimed in claim 17 wherein the sensor for sensing the direction of the load applied to the arm comprises an aircraft attitude sensor.

19. A load reacting unit for a landing gear for an aircraft comprising a shock absorber strut with upper and lower telescoping portions, the upper portion being connectable to the airframe of the aircraft, an arm to extend fore and aft relative to the aircraft and carrying a landing wheel, and a main pivot pivotally connecting the arm to the lower portion of the shock absorber strut; the load reacting unit comprising; a first connector, a first pivot for pivotally connecting the first connector to the shock absorber strut or to the airframe, a second connector, a second pivot for pivotally connecting the second connector to the arm, and a telescopic unit for reacting to load applied between the first and second connectors; and an indicator for monitoring the reaction load in the telescopic unit.

20. A landing gear as claimed in claim 19 in which the telescopic unit has a fluid filled chamber for reacting to load applied between the first and second connectors, and the indicator is a pressure indicator.

21. A landing gear as claimed in claim 20 in which the pressure indicator comprises a mechanical indicator exposed to pressure in the chamber so as to be operated at a predetermined pressure threshold.

22. A landing gear as claimed in claim 21 in which the mechanical indicator cooperates with a spring loaded detent that defines a normal position and an operated position of the indicator.

23. A landing gear as claimed in claim 21 comprising two or more pressure indicators set to operate at different threshold pressures.

24. A landing gear as claimed in claim 20 in which the pressure indicator comprises a pressure sensor generating an output signal in accordance with sensed pressure.

25. A landing gear as claimed in claim 21 in which the indicator comprises a hydraulic sensor generating an output signal in accordance with the speed of reaction movement in the load reacting unit.

26. A method of monitoring the load on a landing gear for an aircraft comprising: a shock absorber strut with upper and lower telescoping portions, the upper portion being connectable to the airframe of the aircraft; an arm to extend fore and aft relative to the aircraft and carrying a landing wheel, and a main pivot pivotally connecting the arm to the lower portion of the shock absorber strut; and a load reacting unit with a first connector, a first pivot for pivotally connecting the first connector to the shock absorber strut or to the airframe, a second connector, a second pivot for pivotally connecting the second connector to the arm, a telescopic unit for reacting to load applied between the first and second connectors, the method comprising monitoring the reaction load in the telescopic unit.

27. A method as claimed in claim 26 further comprising measuring a fluid pressure in the telescopic unit and processing the measurement to calculate a value indicative of the load applied to the arm.

28. A method as claimed in claim 27 further comprising measuring the direction of the load applied to the arm and processing the measured direction to calculate the value indicative of the load applied to the arm.

29. A method as claimed in claim 26, further comprising measuring the pressure and recording the measured pressure, or a value derived therefrom.

30. A method as claimed in claim 26, further comprising measuring the pressure and displaying the measured pressure, or a value derived from the measured pressure.

31. A method as claimed in claim 26, further comprising measuring the pressure and determining whether the measurement, or a value derived therefrom, has exceeded a pre-set threshold.

32. A method as claimed in claim 26 further comprising monitoring a pressure in the telescopic unit and generating an output signal in accordance with the speed of reaction movement in the telescopic unit.
